(19) United States
(12) Patent Application Publication
(10) Pub. No.: US 2026/0072239 A1
(43) Pub. Date: Mar. 12, 2026

(54) LENS BARREL AND IMAGING APPARATUS

(71) Applicant: CANON KABUSHIKI KAISHA, Tokyo (JP)

(72) Inventor: SHINICHIRO HARADA, Kanagawa (JP)

(21) Appl. No.: 19/295,026

(22) Filed: Aug. 8, 2025

(30) Foreign Application Priority Data
Sep. 12, 2024 (JP) 2024-158164

(51) Int. Cl. G02B 7/10

(52) U.S. Cl. CPC G02B 7/102

(57) ABSTRACT

A lens barrel includes a first fixed lens frame that holds a first lens; a second fixed lens frame that holds a second lens; a moving lens frame that moves between the first fixed lens frame and the second fixed lens frame along an optical axis direction of the lens; and a guide bar that supports the moving lens frame so as to be movable along the optical axis direction. The first fixed lens frame and the second fixed lens frame are positioned in a direction orthogonal to the optical axis via the guide bar, and the first fixed lens frame and the second fixed lens frame are positioned in the optical axis direction by a contact portion of the second fixed lens frame coming into contact with the first fixed lens frame.

### BACKGROUND

### Field of the Technology

The present disclosure relates to a lens barrel and an imaging apparatus.

### Description of the Related Art

Conventionally, a fastening member using a screw has been employed as a member for fixing a lens frame that holds a lens to a housing. However, the addition of components such as screws increases the cost. Additionally, a space for screw fastening is required, and the housing tends to become larger. Furthermore, there is a concern that the holding accuracy of the lens may be changed due to stress generated during screw fastening. In the case of a monitoring camera in which high resolution is required, there is a possibility that the influence of the stress in particular will cause problems.

Japanese Patent Application Laid-Open No. 2024-009587 discloses a configuration in which a fixed lens is held by a housing. Specifically, a positioning hole of a fixed lens frame is inserted onto a guide bar that holds a moving lens holder, thereby performing positioning simultaneously with holding of the moving lens holder. Furthermore, a concave portion provided in the optical axis direction in the fixed lens frame engages with a convex portion provided in the housing.

Japanese Patent Application Laid-Open No. 11-072679 discloses a configuration in which a positioning hole of a fixed lens frame is inserted onto a guide bar that holds a moving lens holder, thereby performing positioning simultaneously with holding the moving lens holder. Furthermore, the fixed lens frame is fixed to the housing with an adhesive.

However, in a case in which the conventional technology disclosed in Japanese Patent Application Laid-Open No. 2024-009587 is applied to the lens barrel of the present disclosure, a space for engagement between the fixed lens frame and the housing is required, which may cause an increase in the size of the housing. In addition, in a case in which the conventional technology disclosed in Japanese Patent Application Laid-Open No. 11-072679 is applied to the lens barrel of the present disclosure, there is a concern that the eccentricity accuracy of the lens may deteriorate due to the positioning structure between the housing and the fixed lens frame, since the fixed lens frame is fixed to the housing.

### SUMMARY

The present disclosure is directed to provide a lens barrel capable of suppressing eccentricity of a plurality of lenses while achieving miniaturization.

According to one aspect of the present disclosure a lens barrel comprises a first fixed lens frame that holds a first lens; a second fixed lens frame that holds a second lens; a moving lens frame that moves between the first fixed lens frame and the second fixed lens frame along an optical axis direction of the lens; and a guide bar that supports the moving lens frame so as to be movable along the optical axis direction. The first fixed lens frame and the second fixed lens frame are positioned in a direction orthogonal to the optical axis via the guide bar, and the first fixed lens frame and the second fixed lens frame are positioned in the optical axis direction by a contact portion of the second fixed lens frame coming into contact with the first fixed lens frame.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating the configuration of an imaging apparatus according to an embodiment.

FIG. 2 is a block diagram of the imaging apparatus according to the embodiment.

FIG. 3 is a hardware configuration diagram of the imaging apparatus according to the embodiment.

FIG. 4 is a diagram illustrating an internal configuration of a lens barrel.

FIG. 5A and FIG. 5B are examples of cross-sectional views of the lens barrel according to the embodiment.

FIG. 6A to FIG. 6C are examples of perspective views of the lens barrel according to the embodiment.

### DESCRIPTION OF THE EMBODIMENTS

Hereinafter, embodiments of the present disclosure will be explained in detail with reference to the accompanying drawings. The embodiments to be explained below are examples of means for realizing the present disclosure, and may be appropriately modified or changed depending on the configuration of the apparatus to which the present disclosure is applied and various conditions, and the present disclosure is not limited to the following embodiments.

### First Embodiment

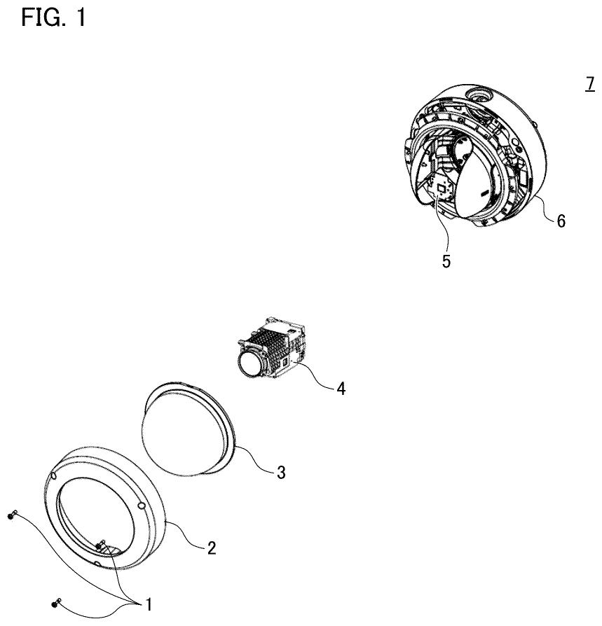

FIG. 1 is a diagram illustrating an example of a configuration of an imaging apparatus (camera) 7 according to the present embodiment. An imaging apparatus 7 is configured to include a cover 2, a dome cover 3, a lens barrel 4, an imaging element 5, and a pan/tilt-rotation unit 6. The imaging apparatus 7 according to the present embodiment is, for example, a network camera (network monitoring camera).

The imaging element 5 includes a semiconductor device such as a Complementary Metal Oxide Semiconductor (CMOS) sensor or a Charge Coupled Device (CCD) sensor. Light transmitted through the imaging optical system is focused on the imaging element 5 and converted into an electric signal. Additionally, although the imaging element 5 has sensitivity to light in the visible light region, it is not limited to this and may instead have sensitivity to light in a non-visible region, such as infrared light. The imaging element 5 is attached to the lens barrel 4.

The pan/tilt rotation unit 6 rotatably holds the lens barrel 4 in the pan direction (horizontal direction) and the tilt direction (vertical direction). It should be noted that the details of the lens barrel 4 according to the present embodiment will be described below.

The cover 2 is an exterior member used to fix the dome cover 3 and the pan/tilt rotation unit 6. The dome cover 3 is a cover member made of plastic (for example, a resin such as polycarbonate (PC)), at least a part of which is transparent or translucent. The dome cover 3 is formed, for example, in a hemispherical shape. Additionally, the dome cover 3 is fastened by fastening screws 1 while being sandwiched between the cover 2 and the pan/tilt rotation unit 6. Accordingly, the lens barrel 4, the imaging element 5, and the like are disposed on the inside of the dome cover 3. The dome cover 3 functions as a protective cover that protects the lens unit and an imaging sensor from raindrops, dust, external impacts, and the like. It should be noted that the dome cover 3 does not necessarily have to be formed in a complete hemispherical shape and may also be partially spherical. Alternatively, the dome cover 3 may also be formed in a polyhedral shape.

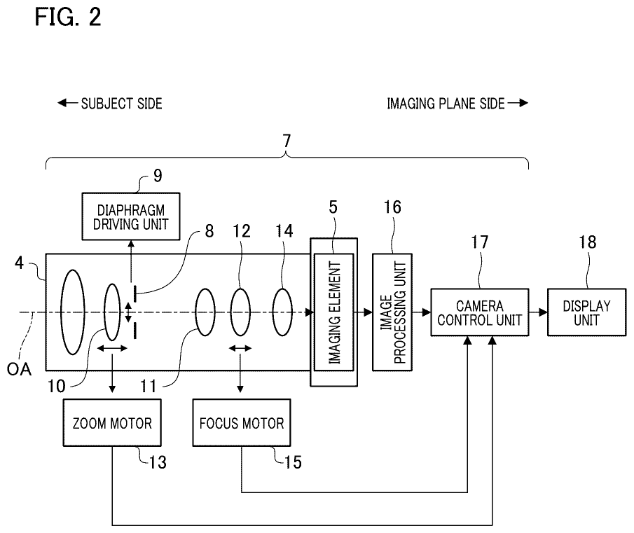

FIG. 2 is a block diagram of the imaging apparatus 7 including the lens barrel 4 and the imaging element 5 according to the present embodiment. The imaging apparatus 7 is configured to further include a diaphragm driving unit 9, a zoom motor 13, a focus motor 15, an image processing unit 16, a camera control unit 17, and a display unit 18.

The imaging apparatus 7 captures a subject image formed by passing through the lens barrel 4 on the imaging element 5. The lens barrel 4 includes a diaphragm 8 that adjusts the amount of incident light, and the diaphragm driving unit 9. The lens barrel 4 further includes a zoom lens 10 that changes the zoom magnification, and a focus lens 12 that performs focus adjustment to form a favorable image on the imaging element 5. The zoom lens 10 is driven by the zoom motor 13. The focus lens 12 is driven by the focus motor 15. The zoom motor 13 and the focus motor 15 are driving units configured, for example, by stepping motors. The lens barrel 4 further includes a fixed lens 11 and a fixed lens 14. The fixed lens 11 is disposed between the zoom lens 10 and the focus lens 12, and the fixed lens 14 is disposed on the rear side (imaging surface side) of the focus lens 12.

The imaging apparatus 7 further includes the image processing unit 16 and the camera control unit 17. The image processing unit 16 performs various types of image processing, such as development processing, color balance processing, gamma processing, and noise reduction processing, on imaging data output from an imaging unit 104, which will be described below, and generates image data and video data. Imaging information (visualized information), such as image data and video data generated by the image processing unit 16, is output to the camera control unit 17. Note that the image processing unit 16 may be configured integrally with other components of the imaging apparatus 7 (within a shared housing) or may be configured separately from the other components of the imaging apparatus 7 (within a separate housing).

The camera control unit 17 includes a CPU, a memory, and the like, is configured by at least one computer, and is connected to each component of the imaging apparatus 7 via a line. For example, the camera control unit 17 controls the movement of the zoom lens 10 and the focus lens 12 by controlling the driving of the zoom motor 13, the focus motor 15, and the like. The camera control unit 17 also functions as a system control unit that performs overall control for each component of the imaging apparatus 7 according to a program stored in the memory, as well as performing the setting of various parameters, and data transmission and reception instructions. Note that the camera control unit 17 may be configured integrally with other components of the imaging apparatus 7 (within a shared housing), may be configured separately from other components of the imaging apparatus 7 (within a separate housing), and may be installed at a location different from the imaging apparatus 7 and remotely controlled.

The display unit 18 is configured by a monitor, a display, and the like. Imaging information, including the image data and video data generated by the image processing unit 16, is transmitted to the display unit 18 by the camera control unit 17. Accordingly, the image data and video data imaged by the imaging apparatus 7 are displayed on the screen of the display unit 18. Note that the display unit 18 may be an information processing apparatus (client apparatus) configured integrally with a display or may be an information processing apparatus (client apparatus) to which a display is connected separately via a line.

Additionally, the lens barrel 4 includes a storage unit (not illustrated) and a communication unit (not illustrated). The storage unit functions as a storage unit capable of temporarily saving (storing) and reading out one or more pieces of image data on which predetermined image processing has been performed by the image processing unit 16. Furthermore, the storage unit is also used as a storage region for programs executed by the camera control unit 17, a storage region for various parameters, and a work area during program execution. The communication unit converts imaging information, such as image data stored in the storage unit, into data conforming to a communication protocol, and delivers the data to an external device (for example, the display unit 18 and a client apparatus). Note that the communication unit is not limited to transmitting image (still image) data and may alternatively generate video data from stored image data, apply compression encoding such as H.264, and distribute the result.

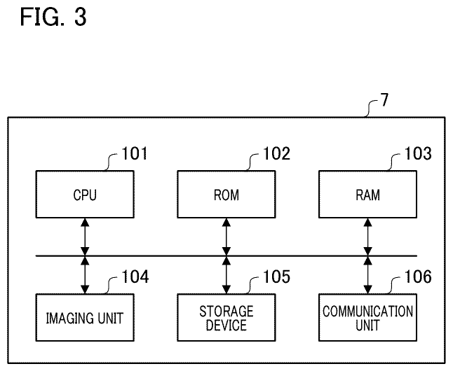

FIG. 3 is a diagram illustrating a hardware configuration of the imaging apparatus 7 according to the present embodiment. The imaging apparatus 7 is configured to include a CPU 101, a ROM 102, a RAM 103, the imaging unit 104, a storage device 105, and a communication unit 106.

The CPU (processor) 101 is a central computing unit that reads out a control program stored in the ROM 102 and executes various processes. The ROM 102 is a non-volatile memory that stores programs for each embodiment, programs necessary for other types of control (control programs), and various data. Since the ROM 102 configures the storage unit (not illustrated) described above, a detailed explanation thereof will be omitted.

The RAM 103 is a volatile memory and is used as a temporary storage region such as a work area or a main memory of the CPU 101. Since the RAM 103 configures the storage unit (not illustrated) described above, a detailed explanation thereof will be omitted. The imaging unit 104 is configured by an imaging optical system composed of optical elements such as a plurality of lenses (for example, the zoom lens 10 and the focus lens 12), a holding member that holds the lenses, an imaging element 5, and the like.

The storage device 105 stores various types of data, various programs, and the like. The storage device 105 is a nonvolatile storage device such as an HDD, a flash memory, or an SD card. The storage device 105 is used as a persistent storage region for the OS, various programs, various data, and the like, and is also used as a temporary storage region for various data and the like. Since the storage device 105 configures the storage unit as described above, a detailed explanation thereof will be omitted. The communication unit 106 performs communication processing with the display unit 18 and an external device such as a client device via a network and the like, using either wired or wireless communication. Since the communication unit 106 configures the communication unit (not illustrated) described above, a detailed explanation thereof will be omitted.

The functions and processes of the imaging apparatus 7 are realized by the CPU 101 reading out a program stored in the ROM 102 and the storage device 105 and executing this program. As another example, the CPU 101 may read out a program stored in a recording medium, such as an SD card, instead of the ROM 102 and the like.

Note that in the present embodiment, although the imaging apparatus 7 executes each operation by using one processor (CPU 101) and one memory (ROM 11), the present disclosure is not limited thereto, and other modes may be adopted. For example, a plurality of processors, a plurality of RAMs, ROMs, and storage devices may cooperate to execute each operation in the imaging apparatus 7. Additionally, some operations or processes may be performed by using hardware circuits. Additionally, a processor other than the CPU may be used to realize the functions and processes of the imaging apparatus 7 to be described below. Furthermore, for example, a graphics processing unit (GPU) may be used instead of the CPU.

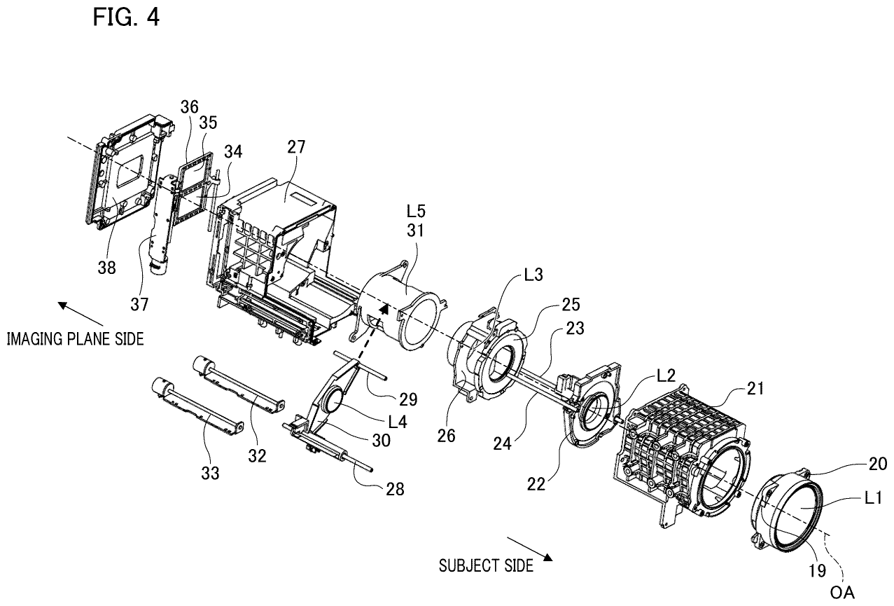

FIG. 4 is a diagram illustrating an internal configuration of the lens barrel 4 according to the present embodiment. The lens barrel 4 of the present embodiment is a lens with five-groups consisting of the groups L1 to L5, in which L1 is disposed closest to the subject side (incident side), and light is incident thereon. Then, L2 is disposed closer to the imaging surface side than L1, L3 is disposed closer to the imaging surface side than L2, L4 is disposed closer to the imaging surface side than L3, and L5 is disposed closer to the imaging surface side than L4. In this context, L1 is a fixed first lens group. L2 is a second lens group that moves in a direction parallel to the optical axis OA (moves along the optical axis OA) to perform a zooming operation. L3 is a fixed third lens group. L4 is a fourth lens group that moves in a direction parallel to the optical axis OA to perform a focusing operation. L5 is a fixed fifth lens group, which will be described below. As described above, the lens barrel 4 of the present embodiment has a plurality of lens groups.

A lens frame (fixed lens frame) 19 that holds the first lens group L1 is fastened and fixed to a housing 21 using four first lens group fixing screws 20. A zoom moving frame 22 that holds the second lens group L2 is supported by a guide bar 23 and a guide bar 24 so as to be movable in the direction of the optical axis OA (a direction parallel to the optical axis OA).

The guide bar 23 and the guide bar 24 are fixed so as to be sandwiched between the housing 21 and the housing 27. A first fixed lens frame 26 that holds the third lens group L3 (a first lens) is fastened to the housing 27 with screws (not illustrated). Additionally, a diaphragm unit 25 is fixed to the first fixed lens frame 26.

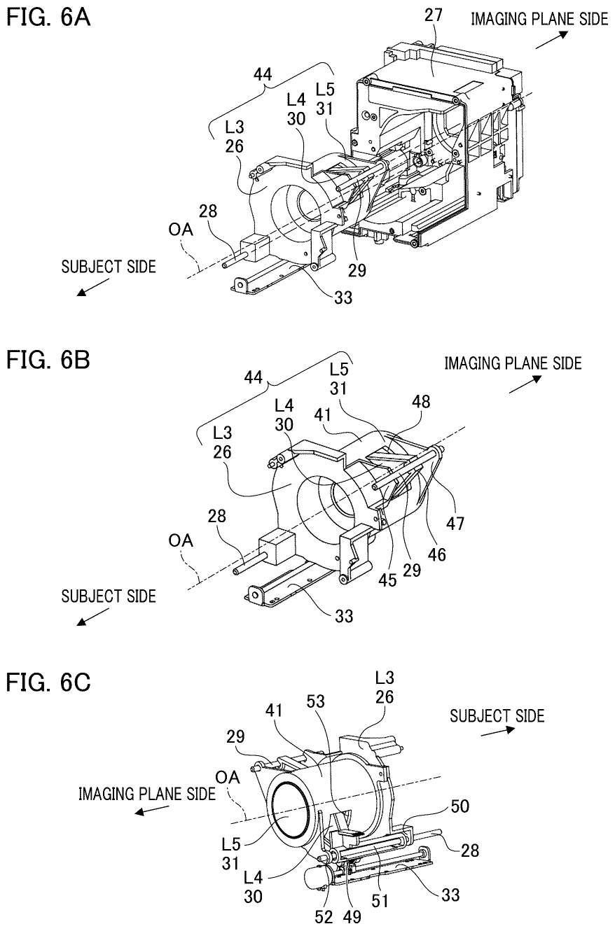

A guide bar 28 (a second guide bar) and a guide bar 29 (a first guide bar) are fixed so as to be sandwiched between the housing 21 and the housing 27. The guide bar 28 and the guide bar 29 are disposed at different positions, as is shown in FIG. 6A to FIG. 6C. A focus moving frame (a moving lens frame) 30 that holds the fourth lens group L4 is supported by guide bars 28 and 29 so as to be movable in the direction of the optical axis OA. That is, the guide bar 28 and the guide bar 29 support the focus moving frame 30 in a direction along the optical axis OA. Note that the first lens group L1 to the fifth lens group L5 are arranged in the direction of the optical axis OA by inserting a part of the focus moving frame 30 into an opening of a second fixed lens frame 31, which will be described below, (in a direction indicated by a dotted arrow in FIG. 4).

The second fixed lens frame 31 holds a fifth lens group L5 (a second lens). A holding method of the second fixed lens frame 31 will be explained in detail below.

A zoom motor 32 is fixed to the housing 27. Since the zoom motor 32 configures the zoom motor 13 described above, a detailed explanation thereof will be omitted. A screw portion of a stepping motor that configures the zoom motor 32 is engaged with a rack (not illustrated) that is connected to the zoom moving frame 22, and the zoom moving frame 22 moves in a direction parallel to the optical axis OA by rotation of the screw.

A focus motor 33 is fixed to the housing 27. Since the focus motor 33 configures the focus motor 15 described above, a detailed explanation thereof will be omitted. A screw portion of a stepping motor that configures the focus motor 33 is engaged with a rack (not illustrated) that is fixed to the focus moving frame 30, and the focus moving frame 30 moves along the optical axis OA by rotation of the screw.

A photo interrupter (not illustrated) is fixed to the housing 27. The same number of photo interrupters is provided as the stepping motors. The positions of the zoom moving frame 22 and the focus moving frame 30 are detected and controlled based on an output of the photo interrupter and a rotating speed of the stepping motor.

A dummy glass 34, an infrared cut filter 35, a filter frame 36, and a filter switching actuator 37 are arranged so as to be sandwiched between the housing 27 and an imaging element holder 38. The dummy glass 34 and the infrared cut filter 35 are held by the filter frame 36. When the filter switching actuator 37 is driven, the dummy glass 34 and the infrared cut filter 35 that are held by the filter frame 36 are moved in a direction perpendicular to the optical axis OA (a direction orthogonal to the optical axis OA) and are switched.

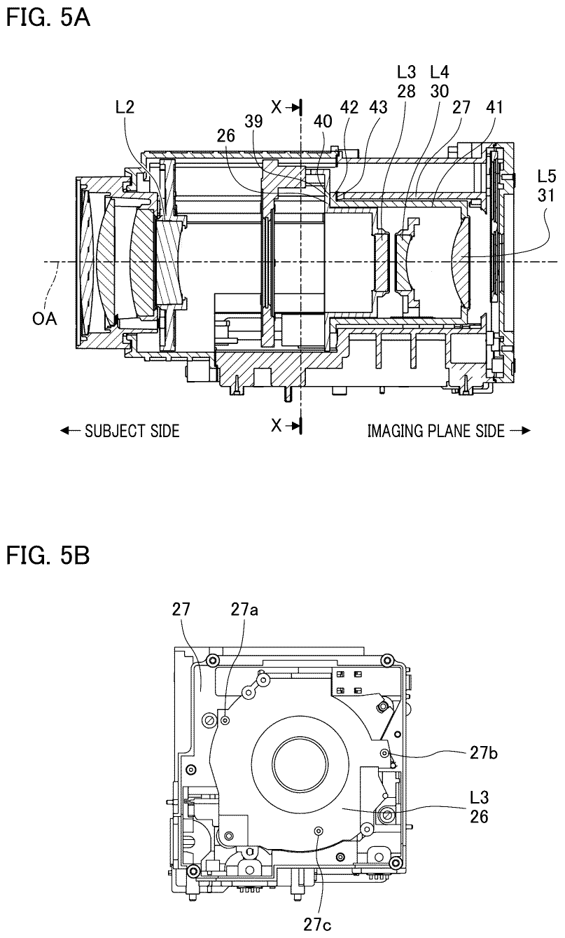

Next, a holding structure of the second fixed lens frame 31 will be explained with reference to FIG. 5A and FIG. 5B. FIG. 5A and FIG. 5B are examples of cross-sectional views of the lens barrel 4 according to the present embodiment. FIG. 5A is an example of the cross-sectional view of the lens barrel 4. FIG. 5B is an X-X cross-sectional view of the first fixed lens frame 26 that holds the third lens group L3, as viewed from the subject side toward the housing 27 side.

The first fixed lens frame 26 that holds the third lens group L3 includes a bottom portion 39. The second fixed lens frame 31 that holds the fifth lens group L5 includes a bottom surface portion 40 (a contact portion). Furthermore, the second fixed lens frame 31 includes a cylindrical portion 41. The bottom surface portion 40 of the second fixed lens frame 31 is formed so as to be connected to the cylindrical portion 41. When the bottom surface portion 39 of the first fixed lens frame 26 and the bottom surface portion 40 of the second fixed lens frame 31 come into contact with each other in the optical axis OA direction, the positions of the first fixed lens frame 26 and the second fixed lens frame 31 in the optical axis OA direction (a direction parallel to the optical axis OA) are determined. That is, positioning of the first fixed lens frame 26 and the second fixed lens frame 31 in the optical axis OA direction is performed by the bottom surface portion 39 and the bottom surface portion 40 coming into contact with each other in the optical axis OA direction.

Furthermore, a surface 42, which is formed on the side of the bottom surface portion 40 that opposes the optical axis OA direction, abuts against (is in contact with) a bottom surface portion 43 that is provided in the housing 27. That is, the second fixed lens frame 31 is held substantially integrally with the first fixed lens frame 26 and the housing 27 in a co-fastened manner, and is fixed by being fastened to the housing 27 using fastening members 27a, 27b, and 27c, which are formed of screws, bolts, and the like. By being configured in this manner, the focus moving frame 30 that holds the fourth lens group L4 can move in the optical axis OA direction between the first fixed lens frame 26 and the second fixed lens frame 31. Specifically, the focus moving frame 30 can move in the optical axis OA direction inside the cylindrical portion 41 that is provided in the second fixed lens frame 31.

Thus, the focus moving frame 30 in the present embodiment is disposed inside the cylindrical portion 41. In the present embodiment, an opening is provided in the cylindrical portion 41 to allow the focus moving frame 30 to be inserted into the cylindrical portion 41. The opening provided in the cylindrical portion 41 will be explained below. Note that the bottom surface portion 40 described above may be, for example, a flange portion, and may also be a seating surface that is capable of coming into contact with the bottom surface portion 39.

FIG. 6A to FIG. 6C are examples of cross-sectional views of the lens barrel 4 according to the present embodiment. FIG. 6A is a perspective view of the inside of the lens barrel 4, which includes a lens holding portion 44 for the third lens group L3 to the fifth lens group L5, and the housing 27. FIG. 6B is a perspective view of the inside of the lens barrel 4 including the lens holding portions 44. FIG. 6C is a perspective view of the inside of the lens barrel 4 including the lens holding portion 44, as viewed from the image element side toward the subject side.

The lens holding portion 44 is configured to include the first fixed lens frame 26, the second fixed lens frame 31, and the focus moving frame 30. As a configuration of the lens holding portion 44, the focus moving frame 30 that holds the fourth lens group L4 is disposed between the first fixed lens frame 26 that holds the third lens group L3 and the second fixed lens frame 31 that holds the fifth lens group L5. The guide bar 28 and the guide bar 29, which are members that support the focus moving frame 30 with respect to the housing 27, are inserted through the lens holding portion 44. That is, the guide bar 28 and the guide bar 29 are inserted through each of the first fixed lens frame 26, the second fixed lens frame 31, and the focus moving frame 30, which configure the lens holding portion 44.

The guide bar 28 and the guide bar 29 are held by the housing 27. Note that the guide bar 28 and the guide bar 29 are also inserted through the focus moving frame 30 in addition to the first fixed lens frame 26 and the second fixed lens frame 31. Therefore, by positioning the plurality of fixed lens frames (the first fixed lens frame 26 and the second fixed lens frame 31) using the guide bars that are also inserted through the moving lens frame (the focus moving frame 30), it is possible to suppress relative decentering with respect to the optical axis OA direction among the three lens groups. By configuring the lens barrel 4 in this manner, it is possible to provide a lens barrel that has a fixed lens holding structure capable of suppressing the decentering of a plurality of lenses. As a result, the imaging apparatus 7 according to the present embodiment can suppress the decentering of the plurality of lenses and can acquire an image of higher quality than the imaging apparatuses in the related art.

Hereinafter, the lens holding portion 44 will be explained in detail with reference to FIG. 6B. The guide bar 29 is engaged with each of a U-groove portion 45 (a first engagement portion) that is provided in the first fixed lens frame 26, a U-groove portion 46 (a second engagement portion) that is provided in the focus moving frame 30, and a U-groove portion 47 (a third engagement portion) that is provided in the second fixed lens frame 31. Accordingly, the guide bar 29 is inserted through the first fixed lens frame 26, the focus moving frame 30, and the second fixed lens frame 31. That is, the plurality of fixed lens frames 26 and 31 and the moving lens frame 30 can be positioned by engaging the guide bar 29 with the U-groove portion that is provided in the first fixed lens frame 26, the U-groove portion that is provided in the focus moving frame 30, and the U-groove portion that is provided in the second fixed lens frame 31.

The first fixed lens frame 26 has a protruding portion formed to extend outward in the radial direction, and the U-groove portion 45 is provided in the protruding portion. Additionally, the focus moving frame 30 has a protruding portion (a first protruding portion) formed to extend outward in the radial direction, and the U-groove portion 46 is provided in the protruding portion. Additionally, the second fixed lens frame 31 has a protruding portion formed to extend outward in the radial direction, and the U-groove portion 47 is provided in the protruding portion.

Additionally, the cylindrical portion 41 of the second fixed lens frame 31 is provided with an opening 48 (a first opening). The opening 48 also functions as an opening for allowing a portion of the focus moving frame 30, including the U-groove portion 46, to protrude outward in the radial direction (radially outward) from the cylindrical portion 41. Specifically, the first protruding portion of the focus moving frame 30 described above is made to protrude outward in the radial direction through the opening 48. That is, the portion (the U-groove portion 46) that engages with the guide bar 29 that is provided on the focus moving frame 30 is configured to be positioned so as to protrude outward in the radial direction from the opening 48. By being configured in this manner, the third lens group L3 to the fifth lens group L5 can be arranged such that their lens centers substantially coincide with each other in the optical axis OA direction.

Furthermore, according to the configuration of the opening 48 in the present embodiment, the mechanical strength of the cylindrical portion 41 can be maintained with a minimal opening while retaining the cylindrical shape, and can thus be kept higher than in a case in which the cylindrical portion 41 is cut out with a deep and wide opening. Therefore, it is possible to prevent variation in the respective dimensions of the second fixed lens frame 31, to maintain dimensional accuracy, and to suppress eccentricity of the lens.

As is shown in FIG. 6C, the focus moving frame 30, with which the guide bar 28 and the guide bar 29 are engaged, is connected to the focus motor 33 via a rack 49, and moves in the optical axis OA direction. The guide bar 28 engages with a first positioning hole portion 50 (a first hole portion) that is provided in the first fixed lens frame 26, a sleeve portion 51 (a support portion) that is provided in the focus moving frame 30, and a second positioning hole portion 52 (a second hole portion) that is provided in the second fixed lens frame 31. Accordingly, the guide bar 28 is inserted through the first fixed lens frame 26, the focus moving frame 30, and the second fixed lens frame 31.

The first fixed lens frame 26 has another protruding portion at a position different from the protruding portion described above, which is formed to extend outward in the radial direction, and the first positioning hole portion 50 is provided in this protruding portion. Additionally, the focus moving frame 30 has another protruding portion (a second protruding portion) at a position different from the protruding portion described above, which is formed to extend outward in the radial direction (a first protruding portion), and the sleeve portion 51 is provided on this protruding portion. Additionally, the second fixed lens frame 31 has another protruding portion at a position different from the protruding portion described above, which is formed to extend outward in the radial direction, and the second positioning hole portion 52 is provided in this protruding portion.

Holes for engaging the guide bar 28 are respectively formed on the side surface of the sleeve portion 51. One hole portion (a third hole portion) is provided on the imaging surface side of the sleeve portion 51, and the other hole portion (a fourth hole portion) is provided on the subject side of the sleeve portion 51. Furthermore, the sleeve portion 51 has an opening between the third hole portion and the fourth hole portion in the optical axis OA direction. The guide bar 28 is engaged with the sleeve portion 51 by being engaged with the third hole portion and the fourth hole portion.

Additionally, the cylindrical portion 41 of the second fixed lens frame 31 is provided with an opening 53 at a position that is different from the position of the opening 48. The opening 53 that is different from the opening 48 also functions as an opening for inserting the focus moving frame 30 into the cylindrical portion 41. After the focus moving frame 30 is inserted into the cylindrical portion 41, the second protruding portion of the focus moving frame 30 described above protrudes outward from the opening 53 in the radial direction. That is, the portion (the sleeve portion 51) that engages with the guide bar 28 that is provided on the focus moving frame 30 is configured to be positioned so as to protrude outward from the opening 53 in the radial direction. By being configured in this manner, the third lens group L3 to the fifth lens group L5 can be arranged such that their lens centers substantially coincide with each other in the optical axis OA direction. Furthermore, according to the configuration of the opening 53 in the present embodiment, similarly to the opening 48, the mechanical strength of the cylindrical portion 41 can be maintained with a minimal opening while retaining the cylindrical shape and can thus be kept higher than in a case in which the cylindrical portion 41 is cut out with a deep and wide opening. Therefore, it is possible to prevent variation in the respective dimensions of the second fixed lens frame 31, to maintain dimensional accuracy, and to suppress eccentricity of the lens.

Additionally, the cylindrical portion 41 that is provided in the second fixed lens frame 31 is disposed at a position closer to the center of the optical axis OA than the positions of the guide bar 28 and the guide bar 29. That is, the cylindrical portion 41 is located on the inner diameter side (radially inner side) with respect to the guide bar 28 and the guide bar 29. This is achieved by inserting the focus moving frame 30 into the cylindrical portion 41 through the opening 53, by allowing the U-groove portion 46 provided in the focus moving frame 30 to protrude through the opening 48, and by allowing the sleeve portion 51 to protrude through the opening 53, whereby the internal space of the lens barrel 4 is efficiently utilized. By being configured in this manner, miniaturization of the lens barrel 4 can be achieved.

Additionally, in the present embodiment, the diameter of the third lens group L3 (first fixed lens) is smaller than that of the fifth lens group L5 (second fixed lens). By being configured in this manner, the cylindrical portion 41 can be efficiently disposed within the internal space of the lens barrel 4, and further miniaturization of the lens barrel 4 can be achieved.

As was described above, the lens barrel 4 of the present embodiment includes the first fixed lens frame 26, the second fixed lens frame 31, and the focus moving frame 30, which moves along the optical axis OA direction between the first fixed lens frame 26 and the second fixed lens frame 31. Furthermore, the guide bar 28 and the guide bar 29, which support the focus moving frame 30 so as to be movable along the optical axis OA, are also provided. Positioning of the first fixed lens frame 26 and the second fixed lens frame 31 in a direction orthogonal to the optical axis OA is performed via the guide bars 28 and 29. Furthermore, positioning of the first fixed lens frame 26 and the second fixed lens frame 31 in the direction along the optical axis is performed by the bottom surface portion 40 of the second fixed lens frame 31 coming into contact with the bottom surface portion 39 of the first fixed lens frame 26.

As was described above, according to the imaging apparatus 7 of the present embodiment, it is possible to provide the lens barrel 4, which includes a fixed lens holding structure capable of suppressing eccentricity of a plurality of lenses while enabling miniaturization.

According to the present disclosure, it is possible to provide a lens barrel that includes a structure capable of suppressing eccentricity of a plurality of lenses while enabling miniaturization.

### Other Embodiments

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

This application claims the benefit of Japanese Patent Application No. 2024-158164, filed Sep. 12, 2024, which is hereby incorporated by reference herein in its entirety.

What is claimed is:

1. A lens barrel comprising:
a first fixed lens frame that holds a first lens;
a second fixed lens frame that holds a second lens;
a moving lens frame that moves between the first fixed lens frame and the second fixed lens frame along an optical axis direction of the lens; and
a guide bar that supports the moving lens frame so as to be movable along the optical axis direction,
wherein the first fixed lens frame and the second fixed lens frame are positioned in a direction orthogonal to the optical axis via the guide bar, and
wherein the first fixed lens frame and the second fixed lens frame are positioned in the optical axis direction by a contact portion of the second fixed lens frame coming into contact with the first fixed lens frame.

2. The lens barrel according to claim 1,
wherein the moving lens frame is disposed inside the second fixed lens frame.

3. The lens barrel according to claim 1,
wherein the guide bar is inserted through the lens frames including the first fixed lens frame, the second fixed lens frame, and the moving lens frame by being engaged with respective engaging portions of the first fixed lens frame, the moving lens frame, and the second fixed lens frame.

4. The lens barrel according to claim 1,
wherein the guide bar includes a first guide bar, and a second guide bar disposed at a different position from the first guide bar.

5. The lens barrel according to claim 4,
wherein the first guide bar is engaged with a first engaging portion of the first fixed lens frame, a third engaging portion of the moving lens frame, and a second engaging portion of the second fixed lens frame.

6. The lens barrel according to claim 4,
wherein the second guide bar is engaged with a first hole portion of the first fixed lens frame, a support portion of the moving lens frame, and a second hole portion of the second fixed lens frame.

7. The lens barrel according to claim 6,
wherein the support portion includes a third hole portion and a fourth hole portion that engage with the second guide bar, and an opening formed between the third hole portion and the fourth hole portion.

8. The lens barrel according to claim 1,
wherein the guide bar includes a plurality of guide bars,
wherein the moving lens frame is provided with portions that engage with the plurality of guide bars, and
wherein the portions that engage with the plurality of guide bars protrude from an opening provided in a cylindrical portion of the second fixed lens frame.

9. The lens barrel according to claim 1,
wherein the moving lens frame is disposed inside a cylindrical portion of the second fixed lens frame,
wherein the moving lens frame has a first protruding portion and a second protruding portion that protrude outward in a radial direction,
wherein the first protruding portion protrudes through a first opening provided in the cylindrical portion, and the second protruding portion protrudes through a second opening provided in the cylindrical portion.

10. The lens barrel according to claim 9,
wherein the guide bar includes a first guide bar, and a second guide bar disposed at a different position from the first guide bar, and
wherein the first protruding portion is provided with a second engagement portion that engages with the first guide bar, and the second protruding portion is provided with a support portion that engages with the second guide bar.

11. The lens barrel according to claim 1, further comprising:
a housing that holds the guide bar,
wherein the first fixed lens frame and the second fixed lens frame are held by the housing via fastening members.

12. The lens barrel according to claim 1, wherein a diameter of the first lens is smaller than a diameter of the second lens.

13. An imaging apparatus comprising:
an imaging element; and
the lens barrel according to claim 1.
